(19) United States
(12) Patent Application Publication
(10) Pub. No.: US 2003/0132858 A1
(43) Pub. Date: Jul. 17, 2003

(54) Solid state pedestrian head having integrated countdown feature

(76) Inventor: Michael C. Hutchison, Plano, TX (US)

Correspondence Address: Robert C. Klinger, Jackson Walker, L.L.P., Suite 600, 2435 North Central Expressway, Richardson, TX, 75080, US

(21) Appl. No.: 10/338,924

(22) Filed: Jan. 8, 2003

Related U.S. Application Data
(60) Provisional application No. 60/346,670, filed on Jan. 8, 2002.

(51) Int. Cl. G08G 1/095

(52) U.S. Cl. 340/944

(57) ABSTRACT

A pedestrian head (10) having a countdown timer associated with both a walking pedestrian symbol, and also the stop hand symbol. This timer indicates the amount of time left until the associated ped head changes state, i.e. from the illuminated walk symbol to the blinking don't Walk hand symbol, and from the blinking don't Walk symbol to the solid illuminated Don't Walk Hand symbol. Preferably, the pedestrian head (10) is a solid state device including a suspended particle (52) such as an LCD, operating as a light filter to generate an illuminated count down display operating in association with the status of the Walk and Don't Walk symbols. Preferably, a diffuser (46) is disposed over the LED array (42) to provide a homogenous light to the suspended particle (52) which modulates the light to control shape i.e. generate a numerical count down display.

### PRIORITY CLAIM

This Application claims Priority of Provisional Application Serial No. 60/346,670, filed Jan. 8, 2002 entitled SOLID STATE PEDESTRIAN HEAD HAVING INTEGRATED COUNTDOWN FEATURE.

### CROSS REFERENCE TO RELATED APPLICATION

This application is related to commonly assigned U.S. Pat. No. 6,323,781 entitled “ELECTRONICALLY STEERABLE LIGHT OUTPUT VIEWING ANGLES FOR TRAFFIC SIGNALS”, the teachings of which are incorporated herein by reference.

### FIELD OF THE INVENTION

The present invention is generally related to pedestrian heads used in traffic control intersections to control pedestrian traffic, and more particularly to pedestrian heads adapted to indicate the operating state thereof.

### BACKGROUND OF THE INVENTION

Conventional pedestrian head signals typically include two electronic display units, one adapted to illuminate a white walking pedestrian Walk symbol, and the other adapted to illuminate an orange Don't Walk hand symbol. Typically, the sequence of events includes illuminating the walk symbol for a predetermined amount of time, then illuminating and flashing the orange stop hand symbol 8 or 9 times indicating the near termination of a safe walking condition.

The inherent disadvantages in this conventional arrangement is that a pedestrian usually does not know how long until the flashing stop hand will become solidly illuminated indicating the end of a safe walking condition. For instance, the pedestrian will not know based on the flashing stop hand symbol how long the symbol has been flashing and when the end of the safe crossing condition will occur. This provides difficulty to a pedestrian, and especially handicapped pedestrians and children, from accurately determining whether or not it is safe to begin crossing a street, or whether or not to hurry to finish crossing a street knowing that the end of the safe crossing condition is about to terminate. Thus, the conventional pedestrian heads fails to allow pedestrians to fully ascertain the true situation of a safe crossing cycle.

### SUMMARY OF THE INVENTION

The present invention achieves technical advantages as a pedestrian head signal providing a countdown timer indicative of the operational status of both the pedestrian walk symbol and the don't walk stop hand symbol. For instance, there is provided a countdown indicator indicating the amount of time until the walking pedestrian symbol and the stop hand symbol change to the next state, i.e. from the white walking symbol to the orange blinking stop hand symbol, and the amount of time until the blinking stop hand symbol changes to the solid stop hand indicating the end of the walk cycle.

A first pedestrian light control apparatus is provided whereby the suspended particle can generate typical pedestrian signals including the walking pedestrian and the illuminated stop hand. A second pedestrian light control apparatus generates a countdown display indicating the time until the pedestrian head changes states. For instance, the countdown timer can indicate the number of seconds until the pedestrian head switches from the pedestrian Walk symbol to the flashing Don't Walk hand signal, or, can indicate the number of seconds until the Don't Walk symbol stops flashing indicating the associated traffic signal turns yellow.

In one preferred embodiment, a suspended particle is positioned over an array of LEDs, such as a liquid crystal display (LCD) device operating as a light switch to control the shape of the light transmitted therethrough, generates a countdown timer in association with a displayed Walk or Don't Walk symbol for controlling pedestrian traffic. A light diffuser is preferably utilized to homogenize the light from the LED array. The suspended particle can selectively pass light over the surface area thereof to generate a numerical indicator as the countdown timer.

### BRIEF DESCRIPTION OF THE DRAWINGS

FIG. 1 is a front view of an automobile traffic control signal having a first LED light adapted to generate red light, and the lower LED light adapted to generate either solid homogenized colors of green or yellow, or green or yellow arrows;

FIG. 2 depicts the apparatus of FIG. 1 with the lower light generating a left turn arrow capable of being displayed in different colors;

FIG. 3a and FIG. 3b depict a pedestrian head system with a first display generating either a Walk symbol or a Don't Walk symbol, and a second adjacent display generating an associated timer indicative of the other symbol status until a change thereof;

FIG. 4 is a front perspective view of one LED apparatus including a suspended particle for generating both solid homogenized light as well as shaped light of different colors according to the present invention;

FIG. 5 is perspective view of the rear of the light of FIG. 4;

FIG. 6 is a side sectional view taken along lines 6-6 in FIG. 4 depicting the LED array, the light diffuser, and the suspended particle disposed over the front lens and modulating the diffused light; and

FIG. 7 is an electrical block diagram illustrating the LED array and suspended particle being controlled by electronics.

### DETAILED DESCRIPTION OF THE PREFERRED EMBODIMENT

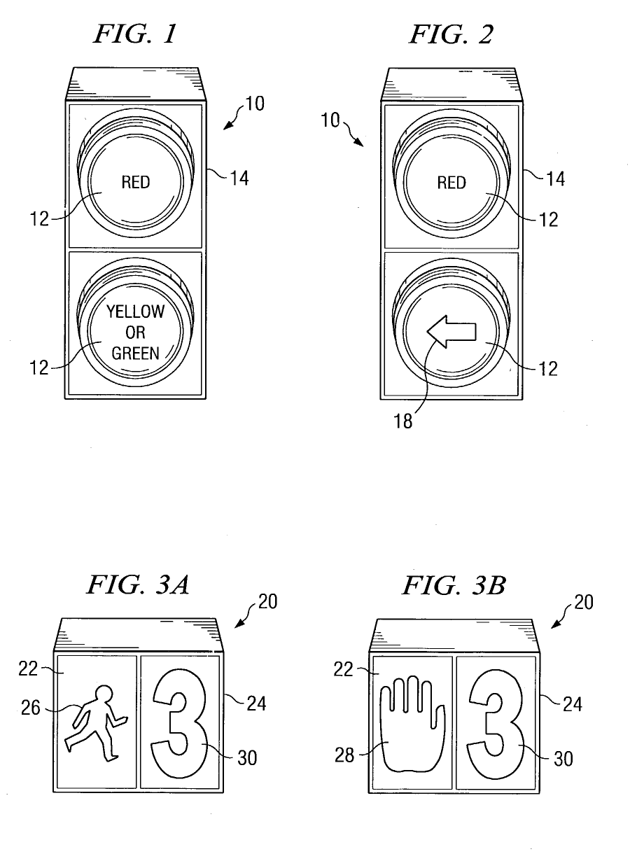

Referring now to FIG. 1, there is depicted generally at 10 a traffic control apparatus having at least two LED light displays generally shown at 12 and mounted within a suitable housing 14. The upper LED light 12 is adapted to generate only red light, while the lower LED light 12 is adapted to generate different colors of lights as well as colored arrows of light, as shown at 18 in FIG. 2. For instance, the lower LED light 12 can generate homogenous light of green or yellow color as well as green or yellow turn arrows, and thus is truly versatile. Two different LED light apparatuses 12 are required to accommodate those drivers who are color blind. As will be discussed shortly, the light beams are generated by a light emitting diode (LED) array. The light beam is homogenized and then filtered by a suspended particle, such as liquid crystal display (LCD) suspended over the lens of the LED light 12. Electronics control the suspended particle to selectively control the shape and color of the light passed according to a control system algorithm for controlling traffic.

Referring to FIG. 3, there is depicted a pedestrian head generally shown at 20, whereby the LED light array having the suspended particle is adapted to control pedestrian traffic. In this embodiment, the light 20 has a first LCD display 22 adapted to selectively create a white pedestrian “Walk” symbol 26 as shown in FIG. 3A, and an orange hand “Don't Walk” symbol as shown at 28 in FIG. 3B. A second adjacent LCD display 24 generates a countdown timer indicator 30 operating in conjunction with the Walk symbol 26 and Don't Walk symbol 28 in FIGS. 3A and 3B. The countdown timer 30 is displayed simultaneously with either the Walk pedestrian symbol 26 or the Don't Walk stop hand symbol 28 to depict the amount of time, for instance in seconds, until the first LCD head 22 changes state, i.e., from the walking symbol 26 to the blinking hand symbol 28, or from the blinking hand symbol 28 to the solid illuminated hand signal 28 associated with a yellow and red traffic light. The apparatus 20 is particularly advantageous in that it indicates to pedestrians how much time is left during the display of the walk symbol, and the time left until the blinking hand symbol becomes solid indicating the associated traffic control light begins to change state, i.e. to yellow and red.

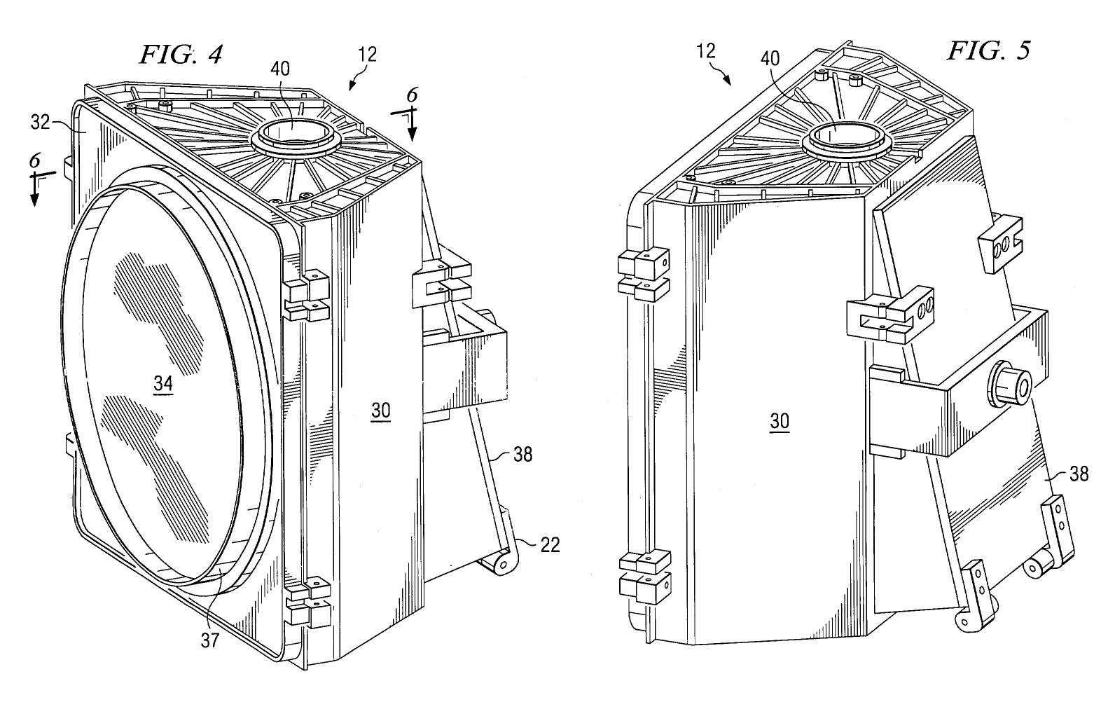

Referring now to FIG. 4, there is depicted one LED light 12 including the suspended particle as previously discussed in regards to the earlier Figures. Light 12 is seen to include a housing 30 having a pivotable front cover 32 holding and securing a clear lens 34. The clear lens 34 is preferably comprised of either glass or plastic, and also provides environmental protection to the underlying suspended particle 36, such as an LCD display as will be discussed shortly with regards to FIG. 5. A light shield 37 is disposed about the lens 34 to shade the light from sunlight. Referring to FIG. 5, the housing 30 is further seen to include a heat conductive rear member 38 comprising a heat sink supporting the array of LEDs mounted thereon and dissipating heat to the ambient. The housing 30 further includes an upper opening 40 and a lower opening 40 (not shown) for facilitating the attachment of one light 12 to another light 12, and to the holding apparatus 14 as shown in FIG. 1. Housing 30 may be formed of metal, but it is preferably comprised of molded plastic to achieve lower cost and lighter weight.

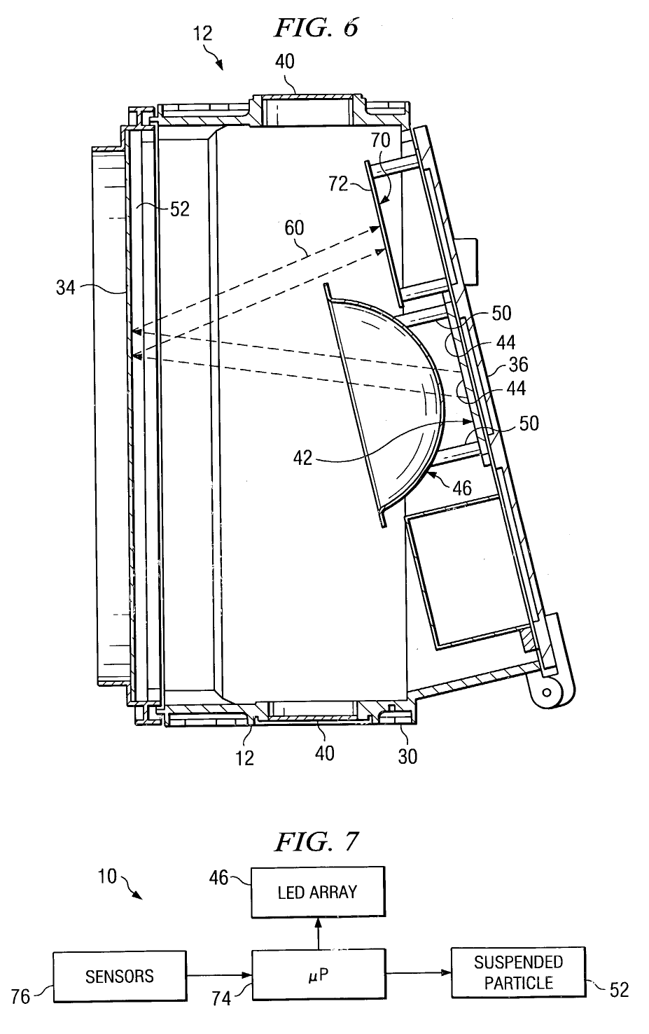

Turning now to FIG. 6, there is illustrated a cross sectional view taken along lines 6-6 in FIG. 4 depicting the light apparatus 12 having an array 42 of LEDs 44 directly mounted upon the heat sink 36. A concave light diffuser shown at 46 is positioned above the LED array 42 by stand offs 50. The diffuser 46 opens upwardly, with a convex surface facing the LED array 42 as shown. This diffuser 46 homogenizes the light from the LED array 42, and directs the homogenized light towards the lens 34 as shown.

Advantageously, a suspended particle 52 operating as a light switch, such as an electrically controllable LCD device, extends across the opening defined by the housing 30 and is protected by the lens 34. The suspended particle 52 operates as an electronic light filter, thus operating as a filter to selectively transmit light therethrough of a desired color, such as green, yellow or red. Since the light is homogenized by the light diffuser 46, the transmitted light is also homogenized of the selected color. Moreover, the directivity of the light generated by the LED array 42 and the lens 34 provides a very focused beam of light.

In addition, the suspended particle 52 is adapted to selectively filter light across the area surface thereof in 2 dimensions, and thus is adapted to pass light of a predetermined shape, such as the arrow shown at 18 in FIG. 2, the pedestrian shown at 22 in FIG. 3A, the stop hand as shown at 24 in FIG. 3B, the numeral as shown at 26 which can count down, or the combination thereof as shown in FIG. 3D.

As shown in FIG. 3D, apparatus 20 is adapted to simultaneously display both a shaped light for controlling pedestrian traffic, such as an orange stop hand 24 which may flash as the count down indicator shown at 26, counts down, such as from 8 seconds to 0 seconds, and which would depict 0 when the hand become continuously illuminated and the associated traffic signal turns yellow and red.

Referring still to FIG. 6, there is shown at 60 that a portion of the light generated from the LED array 42 may backscatter from the suspended particle 52 and the lens 34 to a daughterboard shown at 70 which includes light detection photodiodes 72 to control the intensity of the generated light as a function of the sensed backscattered light.

Referring now to FIG. 7, there is depicted a block diagram of the operating system and electronics for the light 10 and 20 including a microprocessor 74 controlling the LED array 42 to control the light intensity and beam direction generated thereof, as well as controlling the suspended particle 52 to control the light filter passing a selected color of light and defining a shape thereof, and controlling different sensors shown at 76, such as the photodiodes 72 on the daughterboard 70.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

We claim:

1. A pedestrian head, comprising:
a display generating a first symbol indicative of a walk or don't walk condition, wherein said display further generates a second symbol associated with the first symbol indicative of the state of the first symbol.

2. The pedestrian head as specified in claim 1 wherein said second symbol comprises a count indicator indicative of time.

3. The pedestrian head as specified in claim 2 wherein the count indicator is indicative of how much time is left until the first symbol changes states.

4. The pedestrian head as specified in claim 3 wherein the count indicator indicates the time until the first symbol changes from a flashing don't walk symbol to a solid don't walk symbol.

5. The pedestrian head as specified in claim 3 wherein the count indicator indicates the time until the first symbol changes from a walk symbol to a don't walk symbol.

6. The pedestrian head as specified in claim 3 wherein the second symbol is displayed as a function of a traffic control display adapted to control automobile traffic.

7. The pedestrian head as specified in claim 1 wherein the pedestrian head comprises;
a solid state light source comprising an area array of light emitting diodes (LEDs) generating a light output;
a light diffuser positioned over said LED array diffusing said light output; and
a suspended particle adapted to selectively transmit said light output from said light diffuser to generate a controlled light signal.

8. The solid state light specified in claim 7 wherein said suspended particle controls the shape of said controlled light signal.

9. The solid state light specified in claim 8 wherein said suspended particle also controls the color of said controlled light signal.

10. The solid state light specified in claim 9 wherein said controlled light signal is adapted to control automobile traffic.

11. The solid state light specified in claim 9 wherein said controlled light signal is adapted to control pedestrian traffic.

12. The solid state light specified in claim 10 wherein said suspended particle comprises a variable light filter adapted to separately generate at least green and yellow light as said controlled light signal.

13. The solid state light specified in claim 10 wherein said suspended particle device is adapted to separately generate at least a green arrow and a yellow arrow as said controlled light signal.

14. The solid state light specified in claim 13 wherein said suspended particle device is also adapted to separately generate at least a homogenous green and yellow light as said controlled light signal.

15. The solid state light specified in claim 11 wherein said suspended particle comprises a variable filter adapted to alternately generate the controlled light signal to have the shape of a hand and a pedestrian.

16. The solid state light specified in claim 7 wherein said light diffuser is concave and having a convex outer surface facing said LED array.

17. The solid state light specified in claim 6 wherein said suspended particle device comprises an LCD filter.

18. The solid state light specified in claim 6 wherein said controlled light signal has a sufficient intensity meeting DOT requirements.

19. A method of operating a pedestrian head, comprising the steps of:
displaying a first symbol adapted to control pedestrian traffic; and
displaying a second symbol associated with the first symbol indicative of the state of the first symbol.

20. The pedestrian head as specified in claim 19 wherein said second symbol comprises a count indicator indicative of time.

21. The pedestrian head as specified in claim 20 wherein the count indicator is indicative of how much time is left until the first symbol changes states.

22. The pedestrian head as specified in claim 21 wherein the count indicator indicates the time until the first symbol changes from a flashing don't walk symbol to a solid don't walk symbol.

23. The pedestrian head as specified in claim 22 wherein the count indicator indicates the time until the first symbol changes from a walk symbol to a don't walk symbol.
